(19) United States
(12) Patent Application Publication
(10) Pub. No.: US 2022/0281338 A1
(43) Pub. Date: Sep. 8, 2022

(54) CHARGING ROBOT AND CHARGING APPARATUS FOR CHARGING AN ELECTRICAL ENERGY STORE OF A VEHICLE, AND VEHICLE, THE ELECTRICAL ENERGY STORE OF WHICH CAN BE CHARGED WITH SUCH A CHARGING APPARATUS

(71) Applicant: IMS GEAR SE & CO. KGAA, Donaueschingen (DE)

(72) Inventors: Wolfram HOFSCHULTE, Bonndorf (DE); Marco WERSCHLER, Radolfzell am Bodensee (DE); Jens FECHLER, Hüfingen (DE); Uwe BAUMEISTER, Bräunlingen (DE); Daniel REHLE, Niedereschach (DE); Robin TEICHMANN, Konstanz (DE); Marcel MITTELBACH, Schluchsee (DE); Benedikt NAGEL, Brigachtal (DE); Gabriel FUCHS, Reichenau (DE)

(21) Appl. No.: 17/636,551

(22) PCT Filed: Jun. 24, 2020
(86) PCT No.: PCT/EP2020/067718

§ 371 Date: Feb. 18, 2022

(30) Foreign Application Priority Data
Aug. 19, 2019 (DE) 10 2019 122 158.7

(51) Int. Cl. B60L 53/37; B60L 53/16; B60L 53/18; B65H 75/36

(52) U.S. Cl. CPC B60L 53/37; B60L 53/16; B60L 53/18; B65H 75/368; B66F 7/0691

(57) ABSTRACT

A charging robot for charging an electrical energy store of a vehicle, includes a supporting structure, at least one wheel which is fastened rotatably to the supporting structure, a drive unit which is fastened to the supporting structure and with which the wheel can be driven, a first receiving compartment which is fastened to the supporting structure or is formed by the supporting structure, and a second receiving compartment which is fastened to the supporting structure or is formed by the supporting structure. The first receiving compartment and the second receiving compartment are arranged next to each other. A lifting device is arranged in the first receiving compartment and has a contact portion fastened thereto. The contact portion is connectable in an electrically transmitting manner to a mating contact portion of the vehicle. A charging cable is conductively connected to the contact portion.

The present invention relates to a charging robot and a charging apparatus for charging an electrical energy store of a vehicle. Furthermore, the apparatus relates to a vehicle the electrical energy store of which can be charged with such a charging apparatus.

Increasing electrification of vehicles is coming into focus as part of efforts to reduce CO₂ emissions. Whereas vehicles powered by fossil fuels or alternative fuels such as hydrogen can be refueled relatively easily and in a relatively short time, charging the electrical energy store of electrically powered vehicles is a much more complex and lengthy process. A plug connected to a charging station by means of a charging cable is usually connected to a correspondingly designed socket on the vehicle in question to charge the electrical energy store. Once charging is complete, the plug can be removed from the socket and the vehicle can once again be moved. The charging station usually draws its electrical energy from the local power grid. Depending on the design of the charging stations, the charging cable can be wound around a drum in the charging station to prevent the charging cable from being, for example, an obstacle for pedestrians or cyclists.

When a plug and socket are used, the charging process is hereinafter referred to as conductive charging. Alternatively, the charging process can also be carried out inductively, wherein two induction coils are brought as close as possible to each other. However, since the efficiency of an inductive charging process is usually significantly lower than that of a conductive charging process, most charging stations are operated using conductive charging.

The use of charging cables does, however, have several disadvantages: the number of charging cables per charging station is limited. Typically, a charging station has no more than three charging cables. It is, moreover, necessary to park the vehicles in the immediate vicinity of the charging station since the length of the charging cable is limited. In addition, the effective operation of a charging station is only possible to a limited extent. At conventional filling stations where a vehicle powered by fossil fuels or fuels such as hydrogen can be refueled, the vehicle in question stops for a comparatively short time. As mentioned, the charging of the electric energy store of the vehicle in question is a significantly longer process when compared to the refueling of vehicles powered by fossil fuels and fuels such as hydrogen. For this reason, the charging stations are also operated in such a way that a vehicle can be charged overnight while parked. The charging process does not, however, typically take the whole night. If the driver of an electrically powered vehicle connects the vehicle to a charging station installed near their home or in a parking garage in the evening, in order to be able to drive away with a full energy store the next morning, and the charging process is, for example, already completed at midnight, this is associated with considerable inconvenience and it is hardly practical to, on the one hand, remove the plug from the socket, and on the other hand, move the vehicle to another parking space so as to free up the charging station in question for charging the electrical energy store of another vehicle.

To remedy this situation, charging robots have been developed that can insert the plug into the socket without the assistance of the driver of the vehicle concerned and then remove the plug once the charging process is complete. Charging robots of this type are disclosed, for example, in DE 10 2016 014 463 A1, DE 10 2009 006 982 A1, DE 10 2014 107 153 A1, DE 10 2014 226 357 A1, DE 10 2015 117 116 A1, U.S. Pat. No. 9,056,555 B1, U.S. Pat. No. 9,592,742 B1, US 2013 007 6902 A1 and DE 10 2009 001 080 A1. A significant advantage of such charging robots is that the plug is removed from the socket more or less immediately upon completion of the charging process, so that the plug can subsequently be used to charge the electric energy store of another vehicle. The charging station in question can be used much more effectively, but the vehicle must also be removed from the charging station after the charging process is complete so that the charging robot can guide the charging cable to another vehicle.

Available space is limited both in parking garages and in city centers. In a large number of electrically powered vehicles, the socket is located roughly in the same position as the tank filler necks of vehicles powered by fossil fuels, which is to say on the side panel of the vehicle. A charging robot must accordingly therefore have enough space to be able to move to the side of the vehicle. The space available in parking garages or parking places between two adjacent parked vehicles is usually not sufficient for this. It is therefore known, by way of example, from DE 10 2009 001 080 A1, to arrange the socket on the bottom surface of the vehicle and to design the charging robot in such a way that it can move under the vehicle in question. It is, however, necessary for the vehicle to have a certain ground clearance. Ground clearance is, however, very limited, in particular, in the case of sports cars, such that these sport cars cannot be charged with the previously known charging robots if the socket is arranged on the bottom surface. At the same time, a large number of vehicles, especially SUVs, have comparatively high ground clearance.

The task of one embodiment of the present invention, is to propose a charging robot for charging an electrical energy store of a vehicle, with which charging robot vehicles with both minimal and high ground clearance can be charged.

Furthermore, the aim of one configuration of the present invention is the task of providing a charging apparatus with which vehicles with both minimal and high ground clearance can be charged.

Beyond this, the aim of one design of the invention is to provide a vehicle which can be charged with such a charging apparatus.

This task is solved with the features indicated in claims 1, 16 and 19. Advantageous embodiments are the subject of the sub-claims.

One embodiment of the invention relates to a charging robot for charging an electrical energy store of a vehicle comprising:
a supporting structure,
at least one wheel which is fastened rotatably to the supporting structure,
a drive unit which is fastened to the supporting structure, with which the wheel can be driven,
a first receiving compartment which is fastened to the supporting structure or formed by the supporting structure, and
a second receiving compartment which is fastened to the supporting structure or is formed by the supporting structure, wherein
   the first receiving compartment and the second receiving compartment are arranged next to each other,
a lifting device which is arranged in the first receiving compartment, to which lifting device a contact portion is fastened, said contact portion being connectable in an electrically transmitting manner to a mating contact portion of the vehicle, and
a charging cable which is conductively connected to the contact portion, via which electrical energy can be conducted to the contact position, the charging cable running through the second receiving compartment, and
a guide device with which the charging cable is guided in the second receiving compartment.

As mentioned here above, the charging process can be carried out both conductively and inductively. In the conductive charging process, the contact portion is typically designed as a plug and the mating contact portion as a socket, or vice versa. In the inductive charging process, the contact portion and the mating contact portion are often plate-shaped. In both cases, the contact portion and the mating contact portion must be brought into close proximity to each other, such that electrical energy can be transmitted between the contact portion and the mating contact portion. In the inductive charging process, the term “connectable in an electrically transmitting manner” is not to be understood as connectable in the mechanical sense, according to which the contact portion and the mating contact portion come into physical contact with each other. Instead, there remains an air gap, however said gap should be kept as small as possible. During the conductive charging process, the contact portion and the mating contact portion come into physical contact with each other.

The proposed charging robot is, in particular, characterized in that the first receiving compartment and the second receiving compartment are arranged next to each other. Starting with a more or less horizontally extending base, the first receiving compartment and the second receiving compartment ideally lie in one plane and are preferably aligned with one another in the horizontal direction. They are not arranged one above the other in the vertical direction. As a result, the proposed charging robot can be built to be particularly flat, which makes it possible to drive the charging robot under vehicles, in particular sports cars, which have minimal ground clearance, and to connect the contact portion with a mating contact portion arranged on the bottom surface of the relevant vehicle in an electrically transmitting manner.

Furthermore, the charging robot has a guide device with which the charging cable is guided into the second receiving compartment. As mentioned here above, the proposed charging robot can be designed to be particularly flat, although a comparatively large amount of installation space is available in the horizontal direction in relation to the intended use of the charging robot. The second receiving compartment can accordingly be designed so that even a long charging cable can be almost completely accommodated in the second receiving compartment. The guide device ensures that the charging cable does not run in a disorderly manner in the second receiving compartment, but rather is guided in a space-saving manner, making use, in particular, of loops. With an appropriate design and fastening of the charging cable in the second receiving compartment, the walls and cover of the second receiving compartment can already act as guide means.

Due to the fact that the charging cable can be almost completely accommodated inside the charging robot, it is not necessary to equip the charging station with appropriately designed devices, for example drums, to ensure that the charging cable does not form loops in which pedestrians or cyclists could get entangled. In addition, this also prevents the charging robot from having to drive over the charging cable, such that a blockage of the charging robot is prevented. It is even possible to dispense with a charging station altogether. An appropriately equipped socket is sufficient.

As mentioned, there is sufficient space in the horizontal direction under the vehicle in question. In this respect, the first receiving compartment can also have a large horizontal extension, such that the lifting device can utilize the horizontally available space so that it can be extended to such an extent that it can also charge vehicles with greater ground clearance.

According to a further embodiment, the guide device has projections and/or recesses arranged in the second receiving compartment, which interact with the charging cable in order to guide the cable. With projections or recesses, it is possible to guide the charging cable within the second receiving compartment in a particularly simple manner, such that the charging cable can be accommodated as completely as possible within the second receiving compartment. In so doing, the projections and/or the recesses can be configured in such a way that the charging cable is configured in an S-shaped or meandering manner inside the second receiving compartment when the cable is inserted into the second receiving compartment.

In a further developed embodiment, the guide device may comprise at least one stationary pulley. In the following, a stationary pulley shall be understood to be a pulley that can rotate about its own axis of rotation, wherein the axis of rotation as such is not movable. The use of stationary pulleys has the advantage, in particular, that they follow the movement of the charging cable and thus the friction between the pulley and the charging cable is kept low. The insulating sheath of the charging cable is therefore protected.

In a further developed embodiment, the charging robot may comprise a retracting device arranged in the second receiving compartment for retracting the charging cable into the second receiving compartment. Since a comparatively high current is used during charging to reduce the charging time, the charging cables generally have a comparatively large cross-section. As a result, the charging cable is, in itself, relatively stiff, such that when the charging robot is correspondingly moved relative to the charging cable, the charging cable is pushed into the second receiving compartment. In this respect, it is not necessary to provide a retracting device to prevent the charging cable from constituting an obstacle for the charging robot itself or for persons who are in the immediate vicinity of the charging cable. However, with the retracting device, it is possible to retract the charging cable into the second receiving compartment in a targeted manner. In particular, it is possible to keep the charging cable more or less taut, regardless of where the charging robot happens to be. As a consequence, the charging cable cannot form loops. The retracting device can be adjusted so that the charging cable is not overly under tension, in order to prevent the cable from becoming too taut. The mechanical stress associated with this is therefore kept within limits.

In a further embodiment, the retracting device can have at least one drivable pulley. In particular, in conjunction with a stationary pulley, but also with a wall section of the second receiving compartment, a torque can be applied to the charging cable by means of the drivable pulley, whereby the charging cable is extracted from or retracted into the second receiving compartment. In this embodiment, the retracting device can be designed in a particularly simple manner.

A further developed embodiment is characterized in that the drivable pulley is drivable by means of the drive unit. The pulley can have its own drive device, but it makes sense to use the drive unit with which at least one wheel of the charging robot is driven for driving the pulley. In so doing, this ensures, on the one hand, that there is no need for an additional drive device to drive the pulley; on the other hand, it is possible to synchronize the pulley with the drive unit, in particular by mechanical means. The synchronization can be performed with an appropriately designed gearbox. For example, the synchronization can be designed in such a way that, in the event that the charging robot moves toward the charging station, the charging cable is retracted into the second receiving compartment and vice versa. The aforementioned formation of loops of the charging cable is prevented and excessive tension of the charging cable is avoided.

According to a further embodiment, the retracting device has at least one cable-turning rod that is axially displaceable along an axis of displacement between a first end position and a second end position. The charging cable can be deviated by the cable-turning rod in such a way that the largest possible proportion of the charging cable can be accommodated in the second receiving compartment. Because the cable-turning rod can be moved axially, the charging cable can be retracted into and extracted from the second receiving compartment. The charging cable enters the second receiving compartment through an outlet opening. If the cable-turning rod moves away from this outlet opening, the charging cable is retracted into the second receiving compartment and vice versa. Alternatively, the cable-turning rod can be moved between the first and second end positions using its own drive device. The retraction and extraction of the charging cable can be performed in a targeted manner using the drive device.

A further embodiment is characterized in that the cable-turning rod is rotatable about an axis of displacement extending perpendicular to the axis of rotation. In this case, the cable-turning rod is designed like a pulley, whereby the friction acting between the cable-turning rod and the charging cable, particularly during axial displacement, can be reduced. This protects the insulating sheath of the charging cable.

In a further developed embodiment, the cable-turning rod can be preloaded into the first or second end position by means of a preloading element. The preloading element can, in particular, be designed as a spring. The end position to which the cable-turning rod is preloaded can expediently be the one that is furthest away from the opening through which the charging cable enters the second receiving compartment. When the tension on the charging cable is removed, in particular when the charging robot moves toward the charging station, then the tension on the charging cable is removed and the cable is retracted into the second receiving compartment due to the axial movement of the cable-turning rod. The components required for this are comparatively simple and therefore inexpensive to procure.

In a further developed embodiment, the charging cable can be implemented as a ribbon cable. Usually, charging cables have a substantially circular cross-section. A ribbon cable, on the other hand, has a cross-section that approximates a relatively wide and flat rectangle. The ribbon cable can be arranged in such a way that it runs approximately perpendicular through the second receiving compartment. The ribbon cable can be pushed together particularly tightly so that even a very long charging cable can be accommodated in the second receiving compartment. In addition, a ribbon cable can be bent particularly easily about the longitudinal axis, which simplifies retracting it into the second receiving compartment.

In a further embodiment, the charging robot can have a distance measuring device with which the distance of the charging robot to adjacently arranged objects, in particular to the mating contact portion, can be determined. As previously mentioned, one of the most important tasks of the charging robot is to bring the contact portion close enough to the mating contact portion so that electrical energy can be transmitted. To do this, it is necessary that the charging robot have information about the location of the mating contact portion. The charging robot can obtain this information from the distance measuring device. It is therefore not necessary to move the vehicle, the electrical energy store of which is to be charged, to a specific position in relation to the charging station or another reference point. Furthermore, it is also not necessary to place the mating contact portion at a specific location on the vehicle. Rather, the charging robot itself determines the position of the mating contact portion and can independently move to it in such a way that the contact portion can transmit electrical energy to the mating contact portion or vice versa.

A further developed embodiment is characterized in that the distance measuring device comprises a LIDAR instrument. The use of a LIDAR instrument makes it possible in a comparatively simple manner to determine distances to adjacently arranged objects. The LIDAR instrument can have a very space-saving design.

A further embodiment is characterized in that the LIDAR instrument is arranged at least partially on the lifting device. In this embodiment, the LIDAR instrument is raised and lowered using the lifting device together with the contact portion. In so doing, this prevents the extension of the lifting device from negatively influencing the distance determination carried out by the LIDAR instrument.

According to a further embodiment, the first receiving compartment is closed with a first cover plate, in which cover at least one opening is arranged, which opening can be closed with at least one opening flap. The lifting device and the contact portion can be designed in such a way that, in the retracted state of the lifting device, the lifting device and the contact portion are completely arranged within the first receiving compartment. The first cover plate ensures that, in particular, the contact portion is largely protected from external influences such as dust and moisture. If necessary, the opening can be opened by a corresponding movement of the opening flap so that the lifting device can be extended.

A further embodiment is characterized in that the lifting device is implemented as a scissor lifting device. The scissor lifting device is, in particular, characterized in that it is very flat when retracted and yet can be extended very far. In addition, the scissor lifting device can be stopped in any intermediate position between the maximum retracted position and the maximum extended position. As a consequence, the scissor lifting device allows vehicles with significantly different ground clearances to be charged.

One embodiment of the invention relates to a charging apparatus for charging an electrical energy store of a vehicle, comprising
a charging robot according to one of the previous embodiments, and
a vehicle unit that can be fastened to a bottom surface of the vehicle and that is connectable to the store, in which vehicle unit the mating contact portion is arranged.

The technical effects and advantages that can be achieved with the proposed charging apparatus correspond to those addressed by the present charging robot. In summary, it should be noted that vehicles with particularly minimal ground clearance can be charged, in which vehicles the mating contact portion is fastened to the bottom surface. However, vehicles with greater than average ground clearance can also be charged. At the same time, the charging robot itself ensures that the charging cable runs in a taut manner, regardless of its position, so that the charging cable cannot form loops that could be an obstacle for the charging robot itself or for people who are in the immediate vicinity of the charging cable.

In a further embodiment, it is provided that the vehicle unit comprises at least one flap which is movable between a first position and a second position, wherein the mating contact portion is fastened to the flap. In the first position, the flap can close the vehicle unit so that the mating contact portion is protected from external influences. In the second position, the mating contact portion is moved out of the vehicle unit so that it is easily accessible for the charging robot. At the same time, the flap is also used for orientation for the charging robot, since it can be used as an easily recognizable unit for distance determination.

A further developed embodiment specifies that the vehicle unit and/or the flap has markings that are detectable by the distance measuring device. As mentioned, the flap can be used for distance determination because it can be provided with a characteristic contour that can be readily detected by the distance measuring device. Beyond this, additional markings can be arranged in the flap, which can also be detected particularly well by the distance measuring device. Markings of this type can, for example, reflect the light used by the LIDAR instrument to a particularly high degree. In addition, the markings can be arranged in a special pattern, making the flap clearly recognizable as such to the distance measuring device. As a consequence, the markings ensure that the position of the mating contact portion can be determined in a reliable manner.

One embodiment of the invention relates to a vehicle having a bottom surface, wherein a vehicle unit of a charging apparatus according to one of the previously discussed embodiments is fastened to the bottom surface. As mentioned, the arrangement of the vehicle unit on the bottom surface has the advantage that the electrical energy store of vehicles can be charged even if the space between two adjacent parked vehicles is very limited. As a consequence, the arrangement of the vehicle unit on the bottom surface is particularly suitable for parking garages or public parking lots, where usually only a limited space is available, which must be filled out as optimally as possible with vehicles, such that the space between two adjacent parked vehicles is very limited.

Exemplary embodiments of the invention are elucidated in more detail below with reference to the accompanying drawings. Wherein:

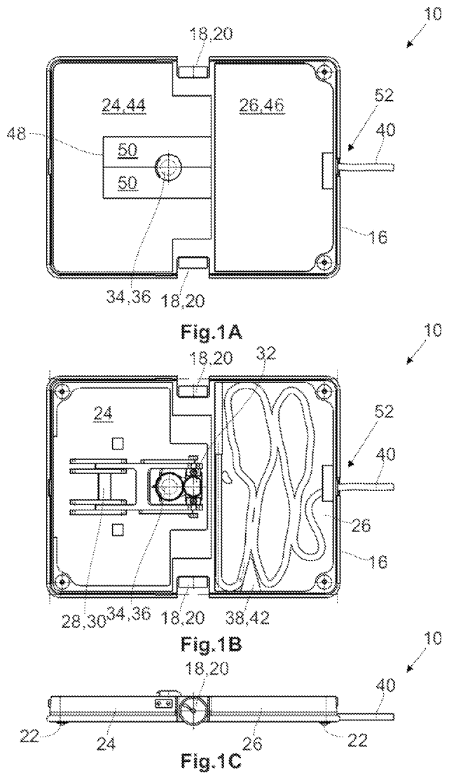

FIG. 1A shows a top view of an embodiment example of a charging robot according to the proposal,

FIG. 1B shows a top view of the embodiment example of the charging robot according to the proposal shown in FIG. 1A without cover plates,

FIG. 1C shows a side view of the embodiment example of the charging robot shown in FIG. 1A,

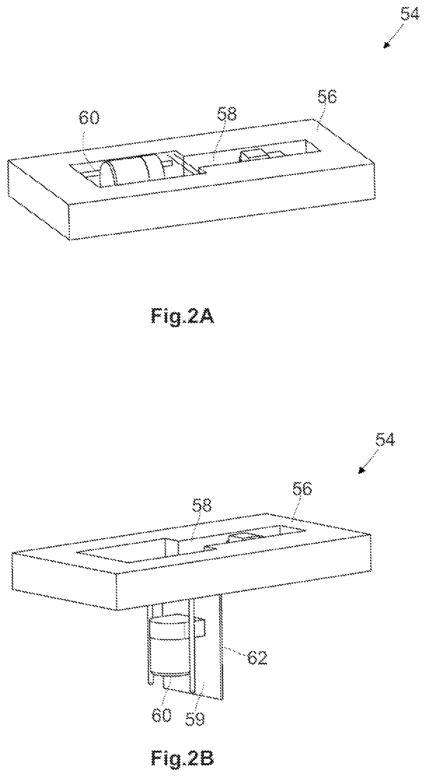

FIG. 2A shows a perspective view of a vehicle unit in a first position,

FIG. 2B shows the vehicle unit shown in FIG. 2A in a second position,

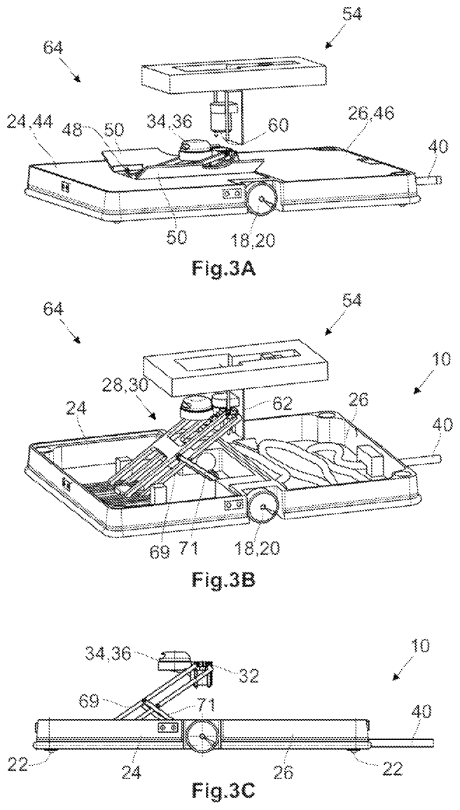

FIG. 3A shows a perspective view of the charging robot shown in FIG. 1A with an opened opening flap, which is arranged underneath the vehicle unit,

FIG. 3B shows a perspective view of the charging robot shown in FIG. 1A without cover plates, located underneath the vehicle unit, with the lifting device extended,

FIG. 3C shows a side view of the charging robot shown in FIG. 1A with the lifting device extended,

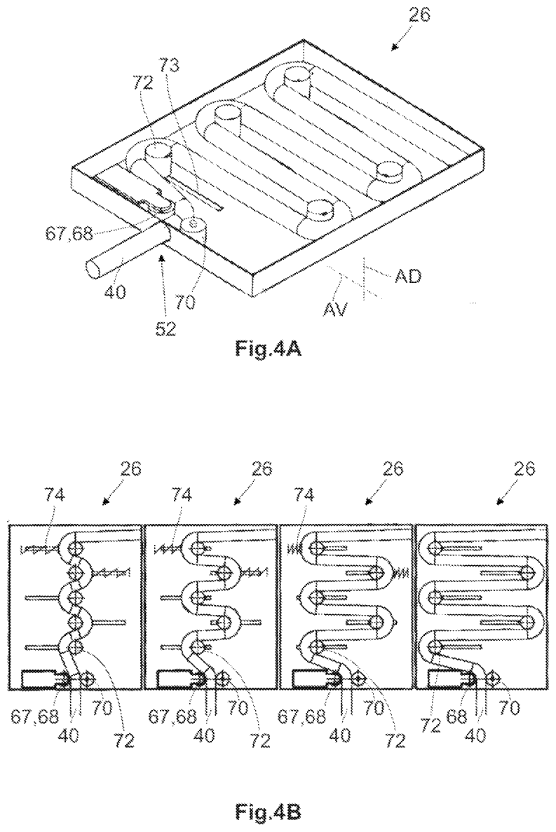

FIG. 4A shows an isolated perspective view of an embodiment example of a second receiving compartment of the charging robot,

FIG. 4B shows the second receiving compartment shown in FIG. 4A in various operating states,

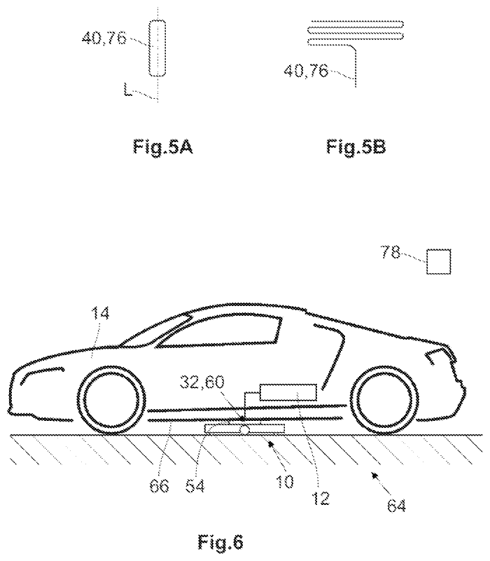

FIG. 5A shows a cross-sectional view of a charging cable implemented as a ribbon cable,

FIG. 5B shows a top view of the ribbon cable shown in FIG. 5A, which is partially folded together, and

FIG. 6 shows a basic side view of a vehicle, the store of which is being charged using a charging apparatus according to the proposal.

FIGS. 1A to 1C show various views of an embodiment example of a charging robot 10 according to the invention, such that the following statements refer to these three figures. The charging robot 10 is used for charging an electrical energy store 12 of a vehicle 14 (Cf. FIG. 6), which will be discussed in more detail later. The charging robot 10 has a supporting structure 16, to which two wheels 18 are fastened rotatably about a common axis of rotation, which wheels are drivable by a drive unit 20 which is likewise also fastened to the supporting structure 16. The drive unit 20 may comprise two wheel hub motors with which the wheels 18 can be driven independently of one another. In addition to these two wheels, four auxiliary wheels 22 (FIG. 1C) are fastened to the supporting structure 16 and are rotatable about an axis of rotation (not shown) that is substantially vertical during intended use. However, the auxiliary wheels 22 themselves are not driven and they ensure that the charging robot 10 does not drag on the ground. Due to the fact that the charging robot 10 only has two driven wheels 18, it can turn around its own axis and is therefore very maneuverable.

In the illustrated embodiment example, the supporting structure 16 forms a first receiving compartment 24 and a second receiving compartment 26, which are arranged side by side. The approximate set-up sees the first receiving compartment 24 arranged on one side and the second receiving compartment 26 arranged on the other side of the common axis of rotation of the two wheels 18. This allows the charging robot 10 to be built very flat. Its height can be reduced to less than 10 cm.

A lifting device 28 is arranged in the first receiving compartment 24, which, as can be seen in particular from FIG. 3B, is implemented as a scissor lifting device 30. A contact portion 32 and a distance measuring device 34 are arranged on the lifting device 28. As will be explained in more detail later, the contact portion 32 and the distance measuring device 34 are arranged on the lifting device 28, such that they are raised and lowered with the lifting device 28. The distance measuring device 34 comprises a LI DAR instrument 36, which can be used to detect the surroundings of the charging robot 10.

A guide device 38 is arranged in the second receiving compartment 26, with which guide device 38 a charging cable 40, which passes through the second receiving compartment 26 and leads to the contact portion 32, can be guided into the second receiving compartment 26. As can be seen, in particular, from FIG. 1B, the guide device 38 comprises a projection 42 which is used to guide the charging cable 40 within the second receiving compartment 26.

The first receiving compartment 24 is closed with a first cover plate 44, whereas the second receiving compartment 26 is closed with a second cover plate 46. The first cover plate 44 and the second cover plate 46 are omitted in FIG. 1B for illustration purposes. From FIG. 1A, it can be seen that the first cover plate 44 has an opening 48 that can be closed with two opening flaps 50. In FIG. 1A, the opening 48 is closed with the opening flaps 50, and it can be seen that in the closed state of the opening flaps 50, the LIDAR instrument 36 is arranged outside the first receiving compartment 24. This ensures that the LI DAR instrument 36 can record the environment of the charging robot 10, largely without obstructions.

The charging cable 40 exits the second receiving compartment 26 via an outlet opening 52, and can be connected to a local power grid via a plug that is not shown.

FIGS. 2A and 2B illustrate an embodiment example of a vehicle unit 54 in a first position and a second position. The vehicle unit 54 substantially comprises a housing 56 which encloses a cavity 58. This cavity 58 can be opened and closed on one side with a flap 59. In the first position, the cavity 58 is closed by the flap 59, whereas in the second position, the flap 59 opens access to the cavity 58. A mating contact portion 60 is arranged on the flap 59, which can also be moved with the flap 59 between the first position and the second position. Markings 62 are arranged on the flap 59, the function of which markings will be discussed in more detail later.

The operation of a proposed charging apparatus 64 comprising the charging robot 10 and the vehicle unit 54 will now be explained referring to FIGS. 3A to 3C. The vehicle unit 54 is mounted on a bottom surface 66 of a vehicle 14, which can be seen in FIG. 6. To charge the electrical energy store 12 of the vehicle 14, the charging robot 10 is moved under the vehicle 14 until it reaches the position relative to the vehicle unit 54 shown in FIG. 3A. The flap 59 of the vehicle unit 54 has already been moved to the second position, so that the distance measuring device 34 can use the flap 59 and in particular the markings 62 arranged on the flap 59 for orientation to determine the position of the mating contact portions arranged on the flap 59. In this respect, the charging robot 10 is able to move itself to the position shown in FIG. 3A. Subsequently, the two opening flaps 50 are opened so that the opening 48 of the first cover plate 44 is released. Thereafter, the lifting device 28 is extended until the contact portion 32 and the mating contact portion 60 are connected in an electrically transmitting manner with one another. The scissor lifting device 30 thereby has a first lever 69 and a second lever 71, wherein the distance measuring device 34 and the mating contact portion 60 are arranged at a first end of the first lever 69. The first lever 69 can, for example, be moved toward and away from the second lever 71 by means of a spindle, that is not shown, that engages a second end. The first lever 69 and the second lever 71 are rotatably connected to each other.

In the illustrated embodiment example, the contact portion 32 and the mating contact portion 60 are designed in the manner of a plug or socket, such that they must be mechanically connected in order to transmit electrical energy. In this case, the charging process is performed conductively. Not shown is an embodiment in which the contact portion 32 and the mating contact portion 60 are essentially designed as plates in which induction coils are arranged so that the electrical energy can be transmitted inductively. In this case, the contact portion 32 and the mating contact portion 60 do not touch one another, however, only a very narrow air gap remains between the contact portion 32 and the mating contact portion 60. However, there is no significant change in the manner of operation of the charging robot 10 and the vehicle unit 54.

As can be seen when referencing FIG. 6, the mating contact portion 60 is connected to an electrical energy store 12 of the vehicle 14 in question via a corresponding line. As soon as the contact portion 32 and the mating contact portion 60 are connected to each other in an electrically transmitting manner, electrical energy can be transmitted from the local power supply system to the electrical energy store 12. The charging process continues on until such time that the electrical energy store 12 is fully charged. Subsequently, the lifting device 28 is then retracted once again, the opening flaps 50 closed, and the flaps 59 of the vehicle unit 54 are returned to the first position. The charging robot 10 can now move onwards to another vehicle 14 whose electrical energy store 12 is to be charged.

With reference to FIG. 1B, the guide device 38 of the second receiving compartment 26 will now be discussed in more detail, with which guide device 38 the charging cable 40 can be guided in the second receiving compartment 26. From FIG. 1B, it is apparent that a portion of the charging cable 40 is looped within the second receiving compartment 26. In order to be able to charge the electrical energy store 12 within an acceptable time, the largest possible current must be able to flow through the charging cable 40. As a consequence, the charging cable 40 has a comparatively large cross-section. It follows from this that the charging cable 40 also has a certain rigidity. With reference to the illustration shown in FIG. 1B, if the charging robot 10 moves to the right, the charging cable 40 is pushed into the second receiving compartment 26 due to the aforementioned rigidity. The guide device 38 ensures that the charging cable 40 is placed in the second receiving compartment 26 in a looped manner. As a result, the second receiving compartment 26 can be used very effectively for placing the charging cable 40, such that even a longer charging cable 40 can be almost completely placed in the second receiving compartment 26. The length of the charging cable 40 can be up to 7 meters. The charging cable 40 is prevented from forming loops, which would be an obstacle for the charging robot 10 or for persons who are in the immediate vicinity of the charging cable 40.

FIGS. 4A and 4B show another embodiment of the second receiving compartment 26 which includes a retracting device 67 for retracting the charging cable 40 into the second receiving compartment 26. Various operating states of the second receiving compartment 26 are shown in FIG. 4B.

The retracting device 67 includes a drivable pulley 68 that cooperates with a stationary pulley 70. The stationary pulley and the drivable pulley 68 are arranged adjacent to the outlet opening 52 through which the charging cable 40 enters the second receiving compartment 26. The charging cable 40 passes between the drivable pulley 68 and the stationary pulley 70. Because of this arrangement, torque can be transmitted from the drivable pulley 68 to the charging cable 40 so that the charging cable 40 can be retracted into or extracted out of the second receiving compartment 26 depending on the direction of rotation of the drivable pulley 68. Furthermore, in the illustrated embodiment example, a total of five cable-turning rods 72 are arranged, which are axially displaceable between a first end position and a second end position along an axis of displacement AV. The axis of displacement AV can be specified, for example, by an aperture 73 through the supporting structure 16. The cable-turning rods 72 may be rotatable about their own axis of rotation AD. As can, in particular, be seen from FIG. 4B, the cable-turning rods 72 are each preloaded into the first end position with a preloading element 74, which end position is shown on the far right in FIG. 4B. For illustrative purposes, only two preloading elements 74 are shown, whereby each of the cable-turning rods 72 can respectively cooperate with one preloading element 74. The charging cable 40 is guided around the cable-turning rods 72 in an S-shaped or meandering manner.

As already mentioned, the charging cable 40 can be connected at its end facing away from the charging robot 10 to a suitably designed socket outlet by means of a plug. When the charging robot 10 moves away from the socket towards a vehicle 14, the charging robot 10 extracts the charging cable 40 at least partially out of the second receiving compartment 26. On the far left of FIG. 4B, an operating state is shown in which the charging cable 40 is extracted a maximum distance out of the second receiving compartment 26. The cable-turning rods 72 are in the second end position. The preloading elements 74 are arranged in such a way that they are preloaded to the maximum in this operating state. If the charging robot 10 now moves back towards the socket, the tension on the charging cable 40 is removed so that the preloading elements 74 pull the cable-turning rods 72 towards the first end position. On the far right of FIG. 4B, an operating state is shown in which the charging cable 40 is retracted to the maximum extent into the second receiving compartment 26. In this operating state, the cable-turning rods 72 have reached their second end position. The other illustrations in FIG. 4B show intermediate positions.

The drivable pulley 68 can intervene in a controlling manner. It can be driven, for example, by the drive unit 20 with which the two wheels 18 are driven. In this way, it is possible to synchronize the movement of the charging robot 10 and the tensioning of the charging cable 40. This can ensure that the charging cable 40 is largely taut during the entire operation so that it cannot form loops. However, it is also possible to avoid applying too much tension to the charging cable 40 to prevent excessive mechanical stress on the charging cable 40.

Not shown is an embodiment in which the cable-turning rods 72 have their own drive device that can be controlled in a targeted manner.

Also not shown is an embodiment in which the pulley and the drivable pulley 68 are adjustable in height along their axis of rotation. In this embodiment example, the charging cable 40 can be stored in multiple layers within the second receiving compartment 26. For this purpose, the second receiving compartment 26 may have a plurality of intermediate bulkheads that, on the one hand, prevent a rearing up of the charging cable 40 and, on the other hand, provide a flat floor to prevent, for example, the portion of the charging cable 40 that is arranged in the second layer from becoming entangled with a portion of the charging cable 40, which could result in an uncontrolled arrangement of the charging cable 40. The height adjustment of the stationary pulley 70 and the drivable pulley 68 can be triggered, for example, by means of a pressure switch activated by the charging cable 40 itself. For example, when the first layer of the second receiving compartment 26 is largely occupied by the charging cable 40, the charging cable 40 will attempt to move out of the way as it is pushed further into the second receiving compartment, whereby a pressure acting on an opposing surface is built up. This pressure can then be used to activate the pressure switch to trigger the height adjustment of the stationary pulley 70 and the drivable pulley 68.

As a consequence, it is possible to place even particularly long charging cables 40 almost completely inside the second receiving compartment 26.

FIGS. 5A and 5B show an embodiment example of the charging cable 40 in which the charging cable 40 is implemented as a ribbon cable 76. FIG. 5A shows a cross-section through the ribbon cable 76, from which it can be seen that the ribbon cable 76 has a substantially rectangular cross-section. Due to this cross-section, the ribbon cable 76 can be bent particularly well around the longitudinal axis L shown in FIG. 5A. FIG. 5B shows a top view of a ribbon cable 76 which has been folded at least partially in a loop-shaped or meandering manner. Due to the fact that on the one hand the ribbon cable 76 can be bent in tight radii and on the other hand is very flat, even a particularly long charging cable 40 can be accommodated in the second receiving compartment 26. The loop-shaped or meandering lay-out of the charging cable 40 is favored when using the ribbon cable 76 design over a circular cross section. Moreover, twisting of the charging cable 40 is avoided in the ribbon cable 76 embodiment, so that the configuration in the second receiving compartment 26 can be well defined. For this purpose, the height of the second receiving compartment 26 space can be selected such that there is only a limited space between the ribbon cable 76 and the ceiling and the floor of the second receiving compartment 26. The floor and the ceiling act as guide means 38, and at the same time the height of the space of the second receiving compartment 26 is optimally utilized.

As mentioned above, FIG. 6 shows a vehicle 14 whose electrical energy store 12 is charged with a charging apparatus 64 according to the proposal. The vehicle 14 shown is intended to be a sports car, which has minimal ground clearance. The ground clearance can roughly be defined as the distance between the ground on which the vehicle 14 rolls and the bottom surface 66 of the vehicle 14. As also mentioned, with the charging robot 10 according to the invention, it is possible to charge vehicles with minimal ground clearance, in which vehicles the vehicle unit 54 is fastened to the bottom surface 66. Due to the fact that the lifting device 28 is implemented as a scissor lifting device 30, it is also possible to charge vehicles 14 with above-average ground clearance, for example SUVs, using the charging robot 10 according to the invention.

The charging apparatus 64 comprises a control unit 78 with which the charging robot 10 is controlled. The control unit 78 communicates with the charging robot 10, for example, via WLAN or other communication standards, expediently in a wireless manner. The control unit 78 can also communicate with the relevant vehicle 14 to exchange vehicle-specific data that can be taken into account during the charging process.

### REFERENCE LIST

10 Charging robot
12 Store
14 Vehicle
16 Supporting structure
18 Wheel
20 Drive unit
22 Auxiliary wheel
24 First receiving compartment
26 Second receiving compartment
28 Lifting device
30 Scissor lifting device
32 Contact portion
34 Distance measuring device
36 LIDAR instrument
38 Guide device
40 Charging cable
42 Projection
44 First cover plate
46 Second cover plate
48 Opening
50 Opening flap
52 Outlet opening
54 Vehicle unit
56 Housing
58 Cavity
59 Flap
60 Mating contact portion
62 Marking
64 Charging apparatus
66 Bottom surface
67 Retracting device
68 Drivable pulley
69 First lever
70 Stationary pulley
71 Second lever
72 Cable-turning rod
73 Aperture
74 Preloading element
76 Ribbon cable
78 Control unit
AD Axis of rotation
AV Axis of displacement
L Longitudinal axis

1. A charging robot (10) for charging an electrical energy store (12) of a vehicle (14), comprising
a supporting structure (16)
at least one wheel which is fastened rotatably to the supporting structure (16),
a drive unit (20) which is fastened to the supporting structure (16), with which the wheel can be driven,
a first receiving compartment (24) which is fastened to the supporting structure (16) or formed by the supporting structure (16), and
a second receiving compartment (26) which is fastened to the supporting structure (16) or is formed by the supporting structure (16), wherein
the first receiving compartment (24) and the second receiving compartment (26) are arranged next to each other,
a lifting device (28) which is arranged in the first receiving compartment (24), to which lifting device a contact portion (32) is fastened, said contact portion (32) being connectable in an electrically transmitting manner to a mating contact portion (60) of the vehicle (14), and
a charging cable (40) conductively connected to the contact portion (32), via which electrical energy can be conducted to the contact portion (32), the charging cable (40) running through the second receiving compartment (26), and
a guide device (38) with which the charging cable (40) is guided in the second receiving compartment (26).

2. Charging robot (10) according to claim 1,
characterized in that the guide device (38) has projections (42) and/or recesses arranged in the second receiving compartment (26), which interact with the charging cable (40) in order to guide the cable.

3. Charging robot (10) according to claim 1,
characterized in that the guide device (38) comprises at least one stationary pulley (70).

4. Charging robot (10) according to claim 1,
characterized in that the charging robot (10) comprises a retracting device (67) arranged in the second receiving compartment (26) for retracting the charging cable into the second receiving compartment (26).

5. Charging robot (10) according to claim 4
characterized in that the retracting device (67) has at least one drivable pulley (68).

6. Charging robot (10) according to claim 5,
characterized in that the drivable pulley (68) can be driven by means of the drive unit (20).

7. Charging robot (10) according to claim 5,
characterized in that the retracting device (67) has at least one cable-turning rod (72) axially displaceable along an axis of displacement (AV) between a first end position and a second end position.

8. Charging robot (10) according to claim 7,
characterized in that the cable-turning rod (72) is rotatable about an axis of rotation (AD) perpendicular to the axis of displacement (AV).

9. Charging robot (10) according to claim 7,
characterized in that the cable-turning rod (72) is preloaded into the first or the second end position by means of a preloading element (74).

10. Charging robot (10) according to claim 1,
characterized in that the charging cable (40) is implemented as a ribbon cable (76).

11. Charging robot (10) according to claim 1,
characterized in that the charging robot (10) has a distance measuring device (34) with which the distance of the charging robot (10) to adjacently arranged objects, in particular to the mating contact portion (60), can be determined.

12. Charging robot (10) according to claim 11,
characterized in that the distance measuring device (34) comprises a LIDAR instrument (36).

13. Charging robot (10) according to claim 12,
characterized in that the LIDAR instrument (36) is at least partially arranged on the lifting device (28).

14. Charging robot (10) according to claim 13,
characterized in that the first receiving compartment (24) is closed with a first cover plate (44), in which at least one opening (48) is arranged which can be closed with at least one opening flap (50).

15. Charging robot (10) according to claim 1,
characterized in that the lifting device (28) is implemented as a scissor lifting device (30).

16. Charging apparatus (64) for charging an electrical energy store (12) of a vehicle (14), comprising
a charging robot (10) according to claim 1, and
a vehicle unit (54) that can be fastened to a bottom surface (66) of the vehicle (14) and that is connectable to the store (12) and in which vehicle unit (54) the mating contact portion (60) is arranged.

17. Charging apparatus (64) according to claim 16,
characterized in that the vehicle unit (54) has at least one flap (59) which is movable between a first position and a second position, wherein the mating contact portion (60) is fastened to the flap (59).

18. Charging apparatus (64) according to claim 17,
characterized in that the vehicle unit (54) and/or the flap (59) has markings (62) which can be detected by the distance measuring device (34).

19. A vehicle (14) having a bottom surface (66), wherein a vehicle unit (54) of a charging apparatus (64) according to claim 16 is fastened to the bottom surface (66).
